(19) United States
(12) Patent Application Publication
(10) Pub. No.: US 2010/0302211 A1
(43) Pub. Date: Dec. 2, 2010

(54) Touch Screen Detecting Method and Apparatus

(75) Inventor: Bin Huang, Beijing (CN)

Correspondence Address: SILICON VALLEY PATENT AGENCY, 7394 WILDFLOWER WAY, CUPERTINO, CA, 95014, US

(73) Assignee: Vimicro Corporation

(21) Appl. No.: 12/786,861

(22) Filed: May 25, 2010

(30) Foreign Application Priority Data
May 27, 2009 (CN) 200910085314.5

(51) Int. Cl. G06F 3/043

(52) U.S. Cl. 345/177

(57) ABSTRACT

Techniques for detecting one or more touches on a touch screen are disclosed. According to one aspect of the present invention, at least three predetermined points are provided, where each of the at least three predetermined points has a wave receptor mounted thereat. When a touch to the touch screen happens, acoustic wave signals generated at the touch point are received by the wave receptors. The distances between the touch point and the three predetermined points are calculated according to the acoustic wave signals. At least three equations of circles are constructed to respectively employ the three predetermined points as their centers, the distances between the touch point and the at least three predetermined points as their radiuses. The coordinates of the touch point according to a common solution of the at least three equations are then determined. The same approach can be similarly applied to determining multiple touches on a touch screen.

### BACKGROUND OF THE INVENTION

1. Field of the Invention

The present invention is related to touch screen detection techniques, more particularly to method and apparatus for detecting touches on a touch screen using an acoustic wave.

2. Description of Related Art

Touch screens are becoming main interface to input or receive information as human-machine interaction. A touch screen is an electronic visual display that can detect the presence and location of a touch within the display area. The term generally refers to touching the display of the device with a finger or hand. A touch detecting means is mounted on the top of a display screen and configured for detecting positions of touch events, receiving touch signals, and then transferring the touch signals to the control device. The control device is mainly configured for receiving the touch signals, converting the touch signals into coordinate positions of the touch events, and then transferring the coordinate positions of the touch events to a central processing unit of a computer. The control device also receives and executes various instructions from the central processing unit.

According to various principles and transmission mediums of the touch panels, the touch panels may be classified into four types including resistance-type touch panels, acoustic wave touch panels, condenser induction touch panels, and infrared touch panels. The acoustic wave touch panels possess relatively better performances such as high accuracy, long life time, high wear resistance, high light transmittance, high definition image quality, and high response speed than the other touch panels. An acoustic wave touch panel relies on mechanical waves travel along a surface of a transmission medium. The acoustic wave touch panel includes a touch screen, wave generators, wave reflectors, a wave receptor, and a control device. The wave generators are respectively attached to the upper left corner and the lower right corner of the touch screen. The wave receptor is attached to upper right corner of the touch screen. The wave reflectors are composed of a number of reflective strips spaced from sparse to dense and 45 degrees inclined.

In operation, the wave generators generate surface acoustic waves propagating along the surface of a touch screen. The surface acoustic waves propagating in the X axis direction and the Y axis direction of the substrate are double reflected by the reflective strips and then received by the wave receptor. The wave receptor concerts the surface acoustic waves into electric signals that are inputted into the control device. When a finger or the like contacts the touch screen, the surface acoustic waves are blocked and scattered along the paths the surface acoustic waves travel. The intensity of the surface acoustic waves is reduced due to the scattering, which results in an attenuate occurring in the wave form of the surface acoustic waves received by the wave receptor at the time the touch screen being contacted. The control device detects the attenuation and determines the location at which the contact occurs on the touch screen.

Only a single point contact can be detected via the above described touch detecting method. When a plurality of fingers or the like block the surface acoustic waves at the same time, the attenuation may be accumulated. Only the accumulated attenuation can be detected by the wave receptor such that the wave receptor can not determine whether the attenuation results from a single point contact or multi-point contacts. Thus, the conventional touch panels cannot detect multi-point contacts.

Thus, there is a need for techniques that can detect multiple respective locations of the touches on a touch screen.

### SUMMARY OF THE INVENTION

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

In general, the present invention is related to detecting one or more touches on a touch screen. According to one aspect of the present invention, at least three predetermined points are provided, where each of the at least three predetermined points has a wave receptor mounted thereat. When a touch to the touch screen happens, acoustic wave signals generated at the touch point are received by the wave receptors. The distances between the touch point and the three predetermined points are calculated according to the acoustic wave signals. At least three equations of circles are constructed to respectively employ the three predetermined points as their centers, the distances between the touch point and the at least three predetermined points as their radiuses. The coordinates of the touch point according to a common solution of the at least three equations are then determined. The same approach can be similarly applied to determining multiple touches on a touch screen.

Many objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1 is a schematic diagram showing an example for explaining a geometrical principle of the present invention;

FIG. 2 is a flowchart or process showing a first touch detecting method according to a first embodiment of the present invention;

FIG. 3 is a schematic diagram showing a touch panel in the touch detecting method shown in FIG. 2;

FIG. 4 is a flowchart or process showing a second touch detecting method according to a second embodiment of the present invention;

FIG. 5 is a schematic diagram showing a touch panel in the touch detecting method shown in FIG. 4; and

FIG. 6 is a structural diagram showing a touch detecting apparatus.

### DETAILED DESCRIPTION OF THE INVENTION

The detailed description of the present invention is presented largely in terms of procedures, steps, logic blocks, processing, or other symbolic representations that directly or indirectly resemble the operations of devices or systems contemplated in the present invention. These descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams or the use of sequence numbers representing one or more embodiments of the invention do not inherently indicate any particular order nor imply any limitations in the invention.

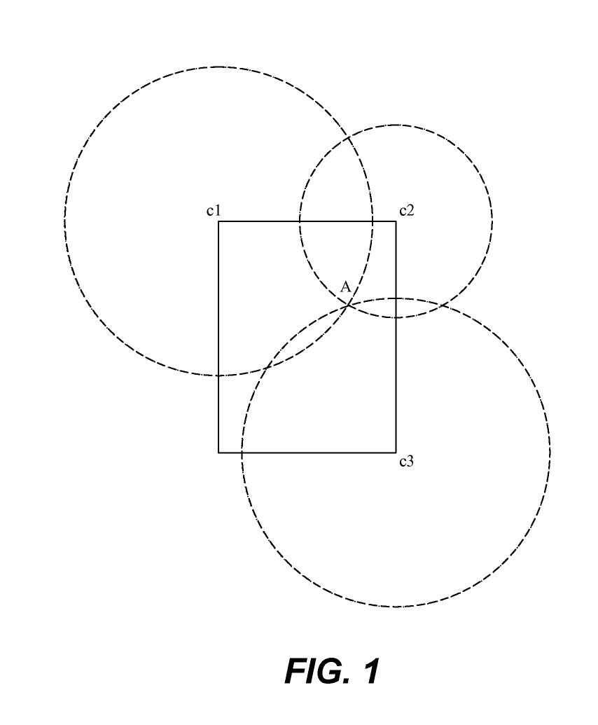

Embodiments of the present invention are discussed herein with reference to FIGS. 1-6. However, those skilled in the art will readily appreciate that the detailed description given herein with respect to these figures is for explanatory purposes only as the invention extends beyond these limited embodiments.

A touch panel in the present invention refers to a surface acoustic wave touch panel, which employs mechanical wave travels along a surface of a solid medium. One difference between the touch panel in the present invention and those conventional touch panels is that the contact motions of a user with the touch panel in the present invention generates acoustic waves, which replaces the wave generators in those conventional touch panels. When a user contacts a touch panel by fingers or the like, the contact motions generate mechanical waves instead of causing changes to the surface acoustic waves generated by the wave generators in those conventional touch panels. However, the new mechanical waves in the present invention may differ from the surface acoustic waves by those conventional touch panels in wave width and wave frequency. The following descriptions illustrate how to determine the location at which the touch or contact occurs.

According to one embodiment, the present invention provides a new detection method for detecting contact signals, which determines one or more contact locations via a geometrical principle. In geometry, a position of a point in a plane can be determined by three circles with predetermined centers and radiuses, which are respectively equal to distances between the position and the predetermined centers of the circles. FIG. 1 shows an example for explaining the geometrical principle. Location of point A in FIG. 1 is to be determined. If the distances between the point A and the points c1, c2, and c3 are given, equations of three circles that set the points c1, c2, and c3 as their centers and take the distances between the point A and the points c1, c2, and c3 as their radiuses can be determined. The point A is the crossing point of the three circles. Thus, the location of the point A can be calculated according to the common solution of the three equations. The ordinary people skilled in the art will readily appreciate how to obtain the common solution of three given equations, so it is omitted hereafter for simplicity. It should be understood that the points c1, c2, and c3 can be any point in the plane, however, the points c1, c2, and c3 are not on a same straight line, and that more than three given points can also help determine the point A.

According to the above described geometrical principle, if distances between a touch point and three or more than three given points on the touch panel are measured, the location of the touch point on the touch panel can be determined. Detailed descriptions are presented through following embodiments.

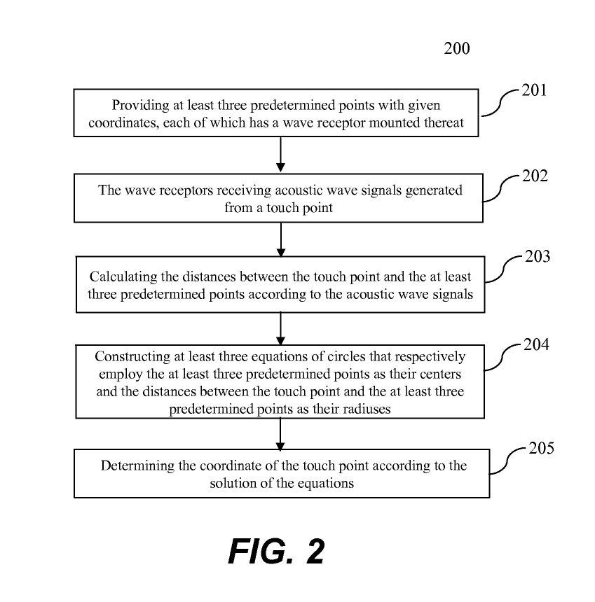

FIG. 2 shows a flowchart or process 200 showing a first touch detecting method according to a first embodiment of the present invention. The process 200 may be implemented in software, hardware or a combination of both. In one embodiment, a module implementing the process 200 is stored in memory and executed in a processor.

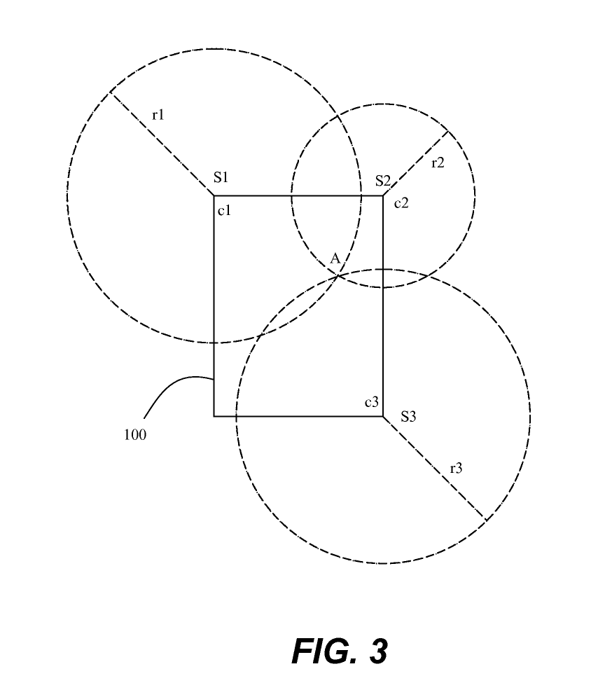

At 201, at least three predetermined points are provided with given coordinates, each of points has a wave receptor mounted thereat. The at least three predetermined points may be defined on or around a touch panel. The at least three predetermined points include predetermined points c1, c2, and c3, which are not along a same straight line. In one embodiment, the predetermined points c1, c2, and c3 are advantageously defined at three corner points of the touch panel. FIG. 3 shows a touch panel 100 having three wave receptors S1, S2, and S3 which are respectively mounted at the predetermined points c1, c2, and c3. Distances between a touch point A and the predetermined points c1, c2, and c3 are respectively symbolized as r1, r2, and r3. During actual application, the absolute coordinates of the point A are not necessarily concerned by users. Thus, reference herein to “coordinate” can mean either absolute coordinates or relative coordinates. Defining the three predetermined points c1, c2, and c3 as the three corner points may be of benefit to adjust their coordinates.

At 202, the wave receptors S1, S2, and S3 receive acoustic wave signals generated at the touch point A. A contact motion happening at the touch point A generates acoustic waves, which propagate in all directions. Thus, each of the wave receptors S1, S2, and S3 may receive an acoustic wave signal at a corresponding time.

At 203, the distances between the touch point A and the at least three predetermined points are calculated according to the acoustic wave signals. The distances between the touch point A and the three predetermined points c1, c2, and c3 can be calculated according to the propagation time of the acoustic wave signals from the touch point A to each of the three predetermined points, which are located in the three corners in the present embodiment.

A method for calculating the distances r1, r2, and r3 between the touch point A and the predetermined points c1, c2, and c3 is detailed herein. Initially, the propagation times of the acoustic wave signals respectively travelling from the touch point A to the predetermined points c1, c2, and c3 are calculated. The time lapse between the time when the acoustic wave signals is generated and the time when one of the wave receptors S1, S2, and S3 receives the acoustic wave signals should be the propagation time from the touch point A to the corresponding one of the predetermined points c1, c2, and c3. Each of the distances r1, r2, and r3 between the touch point A and the predetermined points c1, c2, and c3 is calculated by multiplying the transmission speed of the acoustic waves along the surface of the touch panel and the corresponding propagation time. The transmission speed is symbolized as v. The propagation times from the touch point A to the predetermined points c1, c2, and c3 are respectively symbolized as t1, t2, and t3. The formations referring to the distances r1, r2, and r3 may be presented as follows: r1=v×t1, r2=v×t2, and r3=v×t3.

At 204, at least three equations of circles that respectively employ the at least three predetermined points as their centers and the distances between the touch point and the at least three predetermined points as their radiuses, are constructed. The touch point A is the common crossing point of the three circles.

At 205, the coordinates of the touch point A are determined according to the common solution of the equations. That is, the coordinates of the touch point A can be obtained by geometry operations of the at least three equations.

It is should be noted that another method for calculating the distances r1, r2, and r3 between the touch point A and the three predetermined points (the predetermined points c1, c2, and c3) is also possible. The time when the acoustic wave signals is generated is not necessarily given, however, each time when the wave receptors S1, S2, and S3 respectively receive the acoustic wave signals could be measured and registered by detecting variation of electrical level of the wave receptors. In this method, a first propagation time from the touch point A to the first one of the three receptors receiving the acoustic wave signals is symbolized as t1, with T1 symbolizing the time the first one receiving the acoustic wave signals. A second propagation time from the touch point A to the second one of the three receptors receiving the acoustic wave signals is symbolized as t2, with T2 symbolizing the time the second one has received the acoustic wave signals. A third propagation time from the touch point A to the third one of the three receptors receiving the acoustic wave signals is symbolized as t3, with T3 symbolizing the time the third one has received the acoustic wave signals. The second propagation time t2 can be calculated by adding the first propagation time t1 to the difference value between T2 and T1. The third propagation time t3 can be calculated by adding the first propagation time t1 to the difference value between T3 and T1. That is, t1, t2, and t3 satisfy following requirements or equations: t2=t1+(T2−T1), and t3=t1+(T3−T1). Thus, the distances r1, r2, and r3 should satisfy the following equations: r1=v×t1, r2=v×(t1+(T2−T1)), and r3=v×(t1+(T3−T1)). It is assumed that a value t is equal to t1, the expressions v×t, v×(t+(T2−T1)), v×(t+(T3−T1)) substitute r1, r2, and r3 into the three equations of the circles so as to undergo an iteration algorithm for the three equations until that the three equations have only one common solution.

With t satisfying the equation: v×t≦d, where d stands for the largest distance between any two points on the touch panel, the radiuses of the three equations gradually increase with the increase of t during the iteration algorithm of t being placed into the three equations from zero to t1. When t increases to a certain value so that three circles corresponding to the three equations have only one common crossing point, the certain value should be the desired value of t1. During actual application, a reasonable deviation of the certain value from the desired value of t1 is acceptable. That is, t is approximately equal to t1 (t≈t1). Furthermore, definition of t in the equation v×t≦d may help to prevent the iteration algorithm from being unending under a wrong operation.

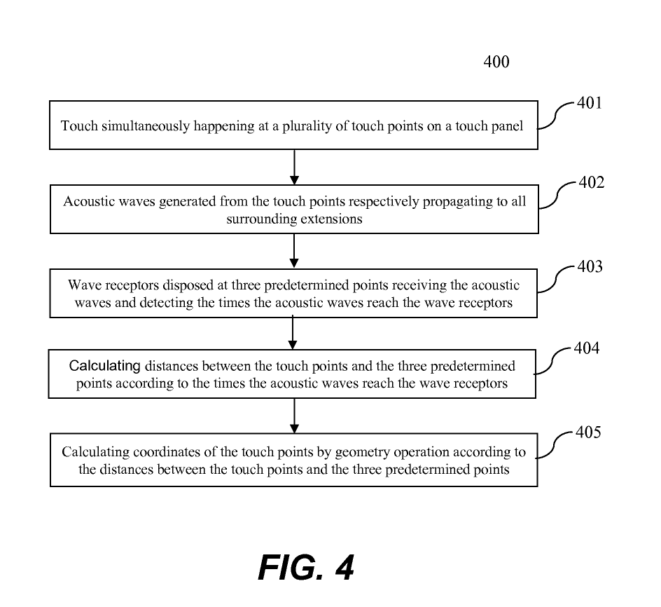

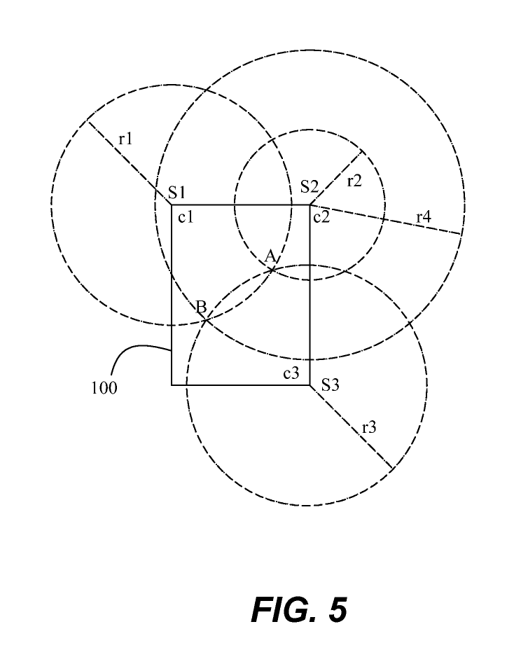

FIG. 4 shows a flowchart or process 400 showing a second touch detecting method according to a second embodiment of the present invention. The process 400 may be implemented in software, hardware or a combination of both. In one embodiment, a module implementing the process 400 is stored in memory and executed in a processor. FIG. 5 illustrates a touch panel with three circles resulting from three points at three corners of the touch panel.

At 401, multiple touches simultaneously happen at a number of touch points on a touch panel. For example, FIG. 5 shows that point A and point B of the touch panel 100 are being touched at the same time. At 402, acoustic waves generated at the touch points respectively propagate in all directions, extending to the boundaries of the touch panel 100.

At 403, wave receptors disposed at three predetermined points receive the acoustic waves and detect the times the acoustic waves reach the wave receptors, respectively. The three predetermined points herein may be exemplarily the three corner points of the touch panel c1, c2, and c3. The point A and the point B shown in FIG. 5, which may be any two of the touch points, are demonstrated for example. The times the acoustic waves respectively reach the wave receptors can be the propagation times. The times that the wave receptor S1 detects are denoted by t1 and t1′. Thus, t1 and t1′ should refer to the time lapses the acoustic waves propagate from the point A and the point B to the wave receptor S1. The times that the wave receptor S2 detects are denoted by t2 and t2′, respectively. Thus, t2 and t2′ should refer to the times the acoustic waves propagate from the point A and the point B to the wave receptor S2. The times the wave receptor S3 detects are denoted by t3 and t3′. Thus, t3 and t3′ should refer to the times the acoustic waves propagate from the point A and the point B to the wave receptor S3. It should be noted that if the distance between the point A and the wave receptor S1 is equal to the distance between the point B and the wave receptor S1, t1 may be equal to t1′.

At 404, distances between the touch points and the three predetermined points are calculated according to the times the acoustic waves reach the wave receptors. The distances between the touch points and the three predetermined points refer to r1 can be obtained according to the equation r=v×t, where r denotes one of the distances, v denotes the transmission speed of the acoustic waves along the surface of the touch panel, and t denotes one of the propagation times.

At 405, the coordinates of the touch points are calculated by geometry operation according to the distances between the touch points and the three predetermined points. Six circle equations that randomly employ the three predetermined points c1, c2, and c3 as their centers and the distances as their radiuses may be constructed. Any three circle equations form a system of equations. Thus, eight groups of systems of equations can be formed according to the principle of permutation and combination. The eight groups of systems of equations are denotes as follows:

f(v×t1); f′(v×t2); f″(v×t3); 1)

f(v×t1); f′(v×t2′); f″(v×t3); 2)

f′(v×t1); f′(v×t2); f″(v×t3′); 3)

f(v×t1); f′(v×t2′); f″(v×t3′); 4)

f(v×t1′); f′(v×t2); f″(v×t3); 5)

f(v×t1′); f′(v×t2′); f″(v×t3); 6)

f(v×t1′); f′(v×t2); f″(v×t3′); 7)

f(v×t1′); f′(v×t2′); f″(v×t3′); 8)

where f(x) denotes the circle equation employing c1 as its center, f′(x) denotes the circle equation employing c2 as its center, and f″(x) denotes the circle equation employing c2 as its center, with x denoting the radius of the circle equation.

If the solution of the system 1) of equations corresponds to one of the touch points A, B, the solution of the system 8) of equations corresponds to the other of the touch points A, B. Thus, the system 1) and the system 8) can simultaneously undergo a geometry operation. The system 2) together with the system 7), the system 3) together with the system 6), and the system 4) together with the system 5) respectively undergo another three geometry operations. Only two of the systems of equations have solutions corresponding to the touch points A, B. As such, the coordinates of the touch points A, B are obtained according the solutions of the two systems of equations, each of which has a unique common solution.

In some cases, t1 may be equal to t1′, or that t2 is equal to t2′, or that t3 is equal to t3′. In those cases, some systems among the eight systems of equations may have the same formation. Only one of the same systems can be maintained, with the others being eliminated. Thus, the geometry operations may become easier, so the steps show how to take the geometry operation is omitted hereafter for simplicity.

It should be understood that more than three predetermined points can be employed to determine the coordinates of the touch points A, B and that more than three circles equations can be constructed to calculate the coordinates of the touch points A, B.

One advantage of the detection method is that the detection method can identify a plurality of touch points. Another advantage of the detection method is that a wave generator and wave reflectors are not necessary in the detection method, which decreases the cost of the touch panel.

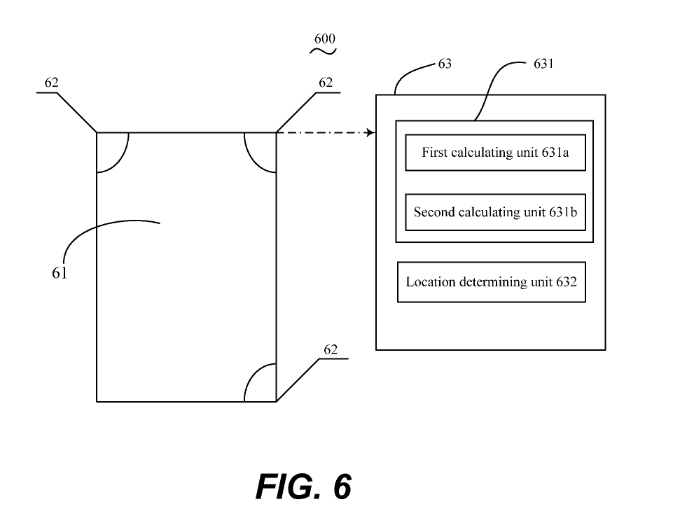

As shown in FIG. 6, a touch detecting apparatus 600 is provided. The touch detecting apparatus 600 includes a touch panel 61, wave receptors 62, and a control device 63. The touch panel 61 can be a flat glass plate mounted on the top of a display screen such as a cathode ray tubes screen, a light-emitting diode screen, a liquid crystal display, or a plasma display. The touch panel 61 should advantageously be a display screen selected from a group consisting of a cathode ray tubes screen, a light-emitting diode screen, a liquid crystal display, and a plasma display, with no glass plate attached thereto, which enable the touch panel possess higher light transmittance.

The number of wave receptors 62 may be three or more. Each of the wave receptors 62 is disposed at a predetermined point on the touch panel 61. Each of the wave receptors 62 may be advantageously attached to one corner of the touch panel 61. The wave receptors 62 are not along a same straight line. The wave receptors 62 are configured to receive acoustic wave signals generated from a touch point on the surface of the touch panel 61, transfer the acoustic wave signals into electric signals, and output the electric signals into the control device 63. The control device 63 is configured to determine the location of one or more touch point.

The control device 63 includes a calculating system 631 configured to calculate distances between the touch point and each of the wave receptors 62 according to the electric signals and a location determining unit 632 configured to determine location of the touch point. The calculating system 631 includes a first calculating unit 631a configured to calculate the times the acoustic wave signals travel from the touch point to each of the wave receptors 62 and a second calculating unit 631b configured to calculate distances between the touch point and each of the wave receptors 62 by multiplying the times and the transmission speed of the acoustic wave signals travelling along the surface of the touch panel 61. The location determining unit 632 is configured to construct at least three circle equations, which respectively employ the location of the wave receptors 62 as their centers and the distances between the touch point and each of the wave receptors 62 as their radiuses. The location determining unit 632 determines the coordinates of the touch points according to the common solution of the at least three circle equations by geometry operation.

When a user touches the touch panel 61, acoustic wave signals are generated at the touch points. The acoustic wave signals travels to the wave receptors 62. The calculating system 631 of the control device 63 calculates the during times the acoustic wave signals travelling from the touch points to the wave receptors 62 and then obtains the distances between the touch points and the wave receptors 62. The location determining unit 632 determines the coordinates of the touch points by geometry operation according to the distances.

One advantage of the touch detecting apparatus 600 is that the touch detecting apparatus 600 can identify a plurality of touch points. Another advantage of the touch detecting apparatus 600 is that a wave generator and wave reflectors are not necessary in the touch detecting apparatus 600, which decreases manufacture cost.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

What is claimed is:

1. A method for detecting a touch point on a touch panel, the method comprising:
providing at least three predetermined points, each of the at least three predetermined points having a wave receptor mounted thereat;
receiving acoustic wave signals generated at a touch point by the wave receptors;
calculating distances between the touch point and the at least three predetermined points according to the acoustic wave signals;
constructing at least three equations of circles that respectively employ the at least three predetermined points as their centers, the distances between the touch point, and the at least three predetermined points as their radiuses; and
determining coordinates of the touch point according to a common solution of the at least three equations.

2. The method according to claim 1, further comprising detecting each time that each of the wave receptors receives the acoustic wave signals.

3. The method according to claim 2, wherein the distances between the touch point and the at least three predetermined points are calculated according to the time that each of the wave receptors receives the acoustic wave signals.

4. The method according to claim 2, wherein the time is a time lapse the acoustic wave signals propagate from the touch point to each of the wave receptors.

5. The method according to claim 1, wherein the at least three predetermined points includes three corner points of the touch panel.

6. The method according to claim 1, wherein the acoustic wave signals are generated from the touch.

7. The method according to claim 1, wherein the at least three predetermined points are not along a same straight line.

8. A method for detecting touch points on a touch panel, the method comprising:
receiving the acoustic waves generated from the touch points by wave receptors disposed at three predetermined points;
detecting times the acoustic waves reach the wave receptors, respectively;
calculating distances between the touch points and the three predetermined points according to the times the acoustic waves reach the wave receptors; and
calculating coordinates of each of the touch points by geometry operation according to the distances between each of the touch points and the three predetermined points.

9. The method according to claim 8, wherein each of the times is a time lapse the acoustic wave signals propagate from one of the touch point to one of the wave receptors.

10. The method according to claim 8, wherein the three predetermined points are respectively three corner points of the touch panel.

11. The method according to claim 8, wherein the plurality of touch points includes two touch points, the touch detecting method further comprising: constructing six circle equations that randomly employ the three predetermined points as their centers and distances between the touch points and the three predetermined points as their radiuses; constructing eight groups of systems of equations by selecting any two of the six circle equations according to the principle of permutation and combination.

12. The method according to claim 11, wherein two of the systems of equations have common solutions, the coordinates of the two touch points being calculated according the solutions of the two systems of equations,

13. An apparatus comprising:
a touch panel;
wave receptors configured to receive acoustic wave signals generated from a touch point on a surface of the touch panel and convert the acoustic wave signals into electric signals, each of the receptors being disposed at a predetermined point on the touch panel;
a control device comprising:
a calculating unit configured to calculate distances between the touch point and each of the wave receptors according to the electric signals; and
a location determining unit configured to construct at least three circle equations which respectively employ the location of the wave receptors as their centers and the distances between the touch point and each of the wave receptors as their radiuses, and determining the coordinates of the touch points according to the solution of the at least three circle equations by geometry operation.

14. The apparatus according to claim 13, wherein the touch panel is a flat glass plate mounted on the top of a display screen.

15. The apparatus according to claim 13, wherein the touch panel is a display screen selected from a group consisting of a cathode ray tubes screen, a light-emitting diode screen, a liquid crystal display, and a plasma display.

16. The apparatus according to claim 13, wherein the calculating unit includes a first calculating unit configured to calculate the times the acoustic wave signals travelling from the touch point to each of the wave receptors and a second calculating unit configured to calculate distances between the touch point and each of the wave receptors by multiplying the times and the transmission speed of the acoustic wave signals travelling along the surface of the touch panel.

17. The touch detecting apparatus according to claim 13, wherein the number of the wave receptors is three or more than three.

18. The touch detecting apparatus according to claim 13, wherein each of the wave receptors is attached to one corner of the touch panel.

19. The touch detecting apparatus according to claim 13, wherein the wave receptors are not along a same straight line.
